(19) United States
(12) Patent Application Publication
(10) Pub. No.: US 2010/0217668 A1
(43) Pub. Date: Aug. 26, 2010

(54) Optimizing Delivery of Online Advertisements

(75) Inventors: Weiguo Liu, Dublin, CA (US); Jinlin Wang, Mountain View, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/393,942

(22) Filed: Feb. 26, 2009

(51) Int. Cl. G06Q 30/00; G06Q 10/00; G06Q 90/00

(52) U.S. Cl. 705/14.52; 705/14.73

(57) ABSTRACT

Disclosed are methods and apparatus for delivering online advertisements. For one of a plurality of users, a probability is obtained for each of a plurality of ads that the one of the plurality of users will click on the one of the plurality of ads. In addition, a lower bound is obtained for each of the plurality of ads. For each of the plurality of ads, a delta between the probability that the one of the plurality of users will click on the one of the plurality of ads and the lower bound for the one of the plurality of ads is determined. One of the plurality of ads to provide to the one of the plurality of users is selected based at least in part on the delta for each of the plurality of ads.

### BACKGROUND OF THE INVENTION

The present invention relates generally to computer implemented and automatic delivery of online advertisements.

When a user visits a web page of a web content provider (i.e., online publisher), the web page often displays some advertisements together with its contents. An advertisement that is displayed via the Internet is often referred to as a banner advertisement. A banner advertisement typically includes a link to a website of the advertiser. When a user clicks on the banner advertisement (e.g., link in the banner advertisement), the user may be redirected to the website advertised in the banner advertisement. A banner advertisement may be placed at a variety of locations of a web page including at the top (i.e., the North), the right hand side (i.e., the East), and the bottom (i.e., the South) of the web page.

Advertisers typically pay online publishers to place their ads on a web page. In a popular pricing model, an advertiser is charged based upon the number of impressions that are delivered. Other pricing models may also be used. For example, in the pay-per-click mode, each advertiser is typically charged only when her ad receives a click.

Advertisers generally request that a minimum number of impressions (i.e., views) be guaranteed. In addition, advertisers may also specify additional conditions that are to be satisfied by the online publisher of the ads. For example, the advertisers may specify a desired target profile of users who are to receive a particular advertisement. As another example, advertisers may also specify a particular position in which an advertisement is to be placed. A publisher will therefore typically attempt to maximize their profits (e.g., by achieving high click-through-rates), while satisfying the requirements of the advertisers. Unfortunately, selecting advertisements to be provided to users while satisfying the requirements of advertisers is a complex process.

### SUMMARY OF THE INVENTION

Methods and apparatus for delivering online advertisements are disclosed. Specifically, the disclosed embodiments support the selection of an ad to be displayed to a particular user. The selected ad may then be displayed to the user (e.g., via a browser).

In accordance with one embodiment, for one of a plurality of users, a probability may be obtained for each of a plurality of ads that the one of the plurality of users will click on the one of the plurality of ads. In addition, a lower bound may be obtained for each of the plurality of ads. For each of the plurality of ads, a delta between the probability that the one of the plurality of users will click on the one of the plurality of ads and the lower bound for the one of the plurality of ads may be determined. One of the plurality of ads to provide to the one of the plurality of users may be selected based at least in part on the delta for each of the plurality of ads.

In accordance with another embodiment, user data associated with a plurality of users may be collected. A statistical model may be generated from the user data, wherein the statistical model indicates, for each of the plurality of users, a probability for each of the plurality of ads that the corresponding one of the plurality of users will click on the one of the plurality of ads. For one of the plurality of users, the probability for each of the plurality of ads that the one of the plurality of users will click on the one of the plurality of ads may be obtained using the statistical model. A lower bound for each of the plurality of ads may be obtained. For each of the plurality of ads, a delta between the probability that the one of the plurality of users will click on the one of the plurality of ads and the lower bound for the one of the plurality of ads may be determined. One of the plurality of ads to provide to the one of the plurality of users may then be selected based at least in part on the delta for each of the plurality of ads.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a diagram illustrating example user data that may be obtained or collected in accordance with various embodiments.

FIG. 3 is a diagram illustrating example statistics representing a statistical model generated from collected data such as that shown in FIG. 2.

FIG. 4 is a process flow diagram illustrating an example method of delivering advertisements in accordance with various embodiments.

FIG. 5 is a process flow diagram illustrating an example of a detailed method of delivering advertisements in accordance with various embodiments.

FIG. 6 is a simplified diagram of a network environment in which various embodiments may be implemented.

FIG. 7 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

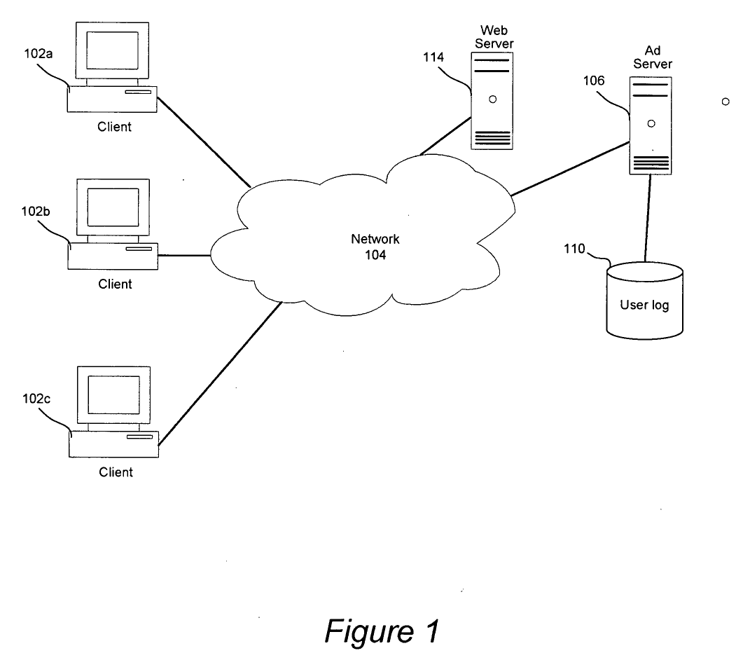

A document may be identified by a Uniform Resource Locator (URL) that identifies a location at which the document can be located. The document may be located on a particular web site, as well as a specific web page on the web site. For instance, a first URL may identify a location of a web page at which a document is located, while a second URL may identify a location of a web site at which the document can be located. FIG. 1 illustrates an example network segment in which various embodiments of the invention may be implemented. As shown, a plurality of clients 102a, 102b, 102c may each receive an impression (i.e., view) of one or more advertisements upon accessing a web page via a web server 114, as will be described in further detail below. Advertisements may also be transmitted by an advertiser server (not shown) maintained by an advertiser (e.g., in the form of pop up windows). Alternatively, an advertisement may be transmitted to the clients 1021, 102b, 102c via electronic mail. The clients 102a, 102b, 102c may be coupled to the web server 114 via a network 104. The network 104 may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

An online publisher may implement a search application. A search application generally allows a user (human or automated entity) to search for information that is accessible via network 104 and related to a search query including one or more search terms. The search terms may be entered by a user in any manner. For example, the search application may present a web page having any input feature to the client (e.g., on the client's device) so the client can enter a query including one or more search term(s). In a specific implementation, the search application presents an input box into which a user may type a query including any number of search terms. Embodiments of the present invention may be employed with respect to any search application. Example search applications include Yahoo! Search, Google, Altavista, Ask Jeeves, etc.

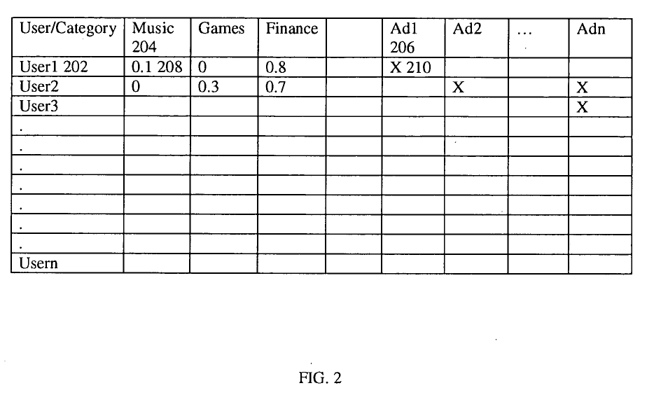

An ad server 106 (or servers) of the online publisher may have access to one or more user logs 110 (e.g., user databases) into which user information is retained. For example, the user logs 110 may be retained in one or more memories that are coupled to the ad server 106. Each time a user performs online activities such as clicking on an advertisement or purchasing goods or services, information regarding such activity or activities may be retained as user data in the user logs 110. For instance, the user data that is retained in the user logs 110 may indicate the identity of web sites visited, identity of ads that have been selected (e.g., clicked, on) and/or a timestamp. User data representing the activities of the users may be retained or summarized in the user logs 110 as scores. Additional user data such as demographic information (e.g., age and/or gender) and/or geographic information (e.g., zip code) may also be retained in the user logs 110. A user may be identified in the user logs 110 by a user ID (e.g., user account ID), information in a user cookie, etc. Example user data that may be stored in the user logs 110 will be described in further detail below with reference to FIG. 2. Where the online publisher supports a search engine (e.g., via the ad server 106 or a separate search server), information associated a search query, such as search term(s) of the search query, information indicating characteristics of search results that have been selected (e.g., clicked on) by the user, and/or associated timestamp may also be retained in the user logs 110.

When a user visits a web page, the system (e.g., ad server 106) may identify the best web advertisement to place in the web page. Embodiments disclosed herein for selecting an advertisement to deliver to a user may be implemented via the ad server 106, which may be coupled to the web server 114, as shown. The disclosed embodiments may be implemented via software and/or hardware.

An online publisher (i.e., web publisher) will generally be responsible for delivering multiple advertisements via the Internet. A contract agreement associated with a particular advertisement may specify a minimum number of page views (i.e., impressions) to be delivered within a particular period of time. The web publisher is therefore responsible for providing the requested number of impressions for each advertisement.

An advertisement may include content which may be delivered via the Internet. The content typically includes text. However, it is important to note that an advertisement may include text, one or more images, video, and/or audio. An advertisement may also include one or more hypertext links, enabling a user to proceed with the purchase of a particular product or service.

The disclosed embodiments support the dynamic selection of advertisements to be provided to users. For instance, selected advertisement(s) may be provided to a user via the Internet. Specifically, when a user visits a web page via the Internet, the system may automatically select one or more advertisement(s) to be served to the user. The publisher may then automatically provide the selected advertisement(s) to the user.

The user data may indicate prior behavior of the plurality of users. The prior behavior of each of the plurality of users may be monitored with respect to a plurality of categories. For instance, each of the plurality of categories may identify a type of Internet content contained in web sites or web pages that may be visited by a user. In addition, the system may monitor and track those ads that are clicked on by each user.

FIG. 2 is a table illustrating example user data that may be collected in accordance with various embodiments. In this example, the user data indicates for each of a plurality of users 202, prior behavior with respect to a plurality of categories 204 and a subset of a plurality of ads 206 previously clicked on (e.g., during a particular period of time). In this example, the categories 204 include Music, Games, and Finance. However, it is important to note that these categories 204 are merely illustrative, and therefore these particular categories may or may not exist in the user logs 110. The user data indicating prior behavior of the users 202 may be ascertained from the user logs 110, as well as other sources of user data (e.g., user account information, cookie, purchase history, etc.).

For each of the users 202, a score 208 representing the user's prior behavior may be stored in association with each of the categories 204. The score 208 may indicate a level of interest of the user 202 in the corresponding category 204 based upon prior Internet activity of the user 202. Thus, the score 208 may indicate the likelihood of the user 202 to click on an ad containing content that falls within that particular category 204. The Internet activity may include those web sites or web pages visited or clicked on by the user. The amount of time spent by the user on the web sites or web pages, the frequency and/or recency, and/or other parameters of the visit may also be factored into the user's score 208. The user's online commercial activities (e.g., in association with various categories 204) can be particularly interesting and factored into the score 208 with a higher weight. The user's commercial activities may include clicking on advertisements, filling out a purchase leading form (e.g., in association with a particular advertisement) and/or purchasing goods or services (e.g., via a particular web site or in association with a particular advertisement). Data obtained from a search engine may also be incorporated into the user's score 208. Each score 208 may be a numerical value. In this example, the scores 208 are values between 0 and 1. However, the scores 208 may be represented using other value ranges.

The user data may also indicate a subset of the advertisements 206 that have been clicked on by the user 202 (e.g., during a particular period of time). In this example, a “X” indicates that the user 202 clicked on the corresponding advertisement 206, as shown at 210. Specifically, as shown in this example, User1 has clicked on Ad1, User2 has clicked on Ad2 and Adn, and User3 has clicked on Adn.

Although not shown in this example, the user data associated with each of the plurality of users may indicate a geographical location, age, and/or sex of each of the plurality of users. The user data may also indicate a purchase history of each of the plurality of users.

In this example, the user data is represented by a table. However, it is important to note that the user data may be stored in a variety of formats.

The user data may be collected over a period of time (e.g., days, weeks, or months). Since the user data may become outdated, the system may purge the oldest user data. For instance, the system may maintain the user data for a period of several days. The system may also implement a time decay function to weight an older event less than a fresh event.

Given historical user data, finding an optimal delivery plan is possible. Specifically, one can maximize the probability of a user clicking on an advertisement based upon previously collected user data. For a popular web page, the statistics of daily visitors' categories can be quite stable. In other words, tomorrow's visitors are generally statistically quite similar to today's visitors. Therefore, today's optimal solution can be used as a base to deliver tomorrow's advertisements. Accordingly, once the user data has been collected, the system may generate a statistical model from the user data.

For a popular ad space, the number of page viewers and therefore the number of impressions on a given day can be very large. In this case, we can partition the historical data by time of the day, such as morning, afternoon, and/or evening. In other words, user data that is collected may be categorized and partitioned accordingly. Not only does this make the problem size much more manageable, but the factor of time of day may be build into the model.

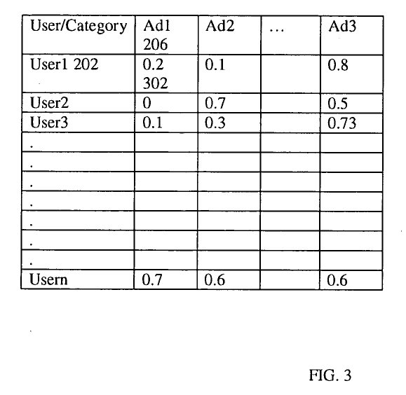

FIG. 3 is a table illustrating an example of results from a statistical model that may be generated from or applied to user data such as that shown in FIG. 2 in accordance with various embodiments. The statistical model may indicate for each of the plurality of users 202, an estimated probability 302 for each of the plurality of ads 206 that the user 202 will click on the one of the plurality of ads 206. As shown in this example, the probability 302 may be represented by a numerical value between 0 and 1. However, the probability 302 may be represented using other value ranges, as well. Unfortunately, simply delivering an ad with the highest probability of being clicked on by a user will typically not fulfill the advertisers' requested number of impressions (i.e., page views).

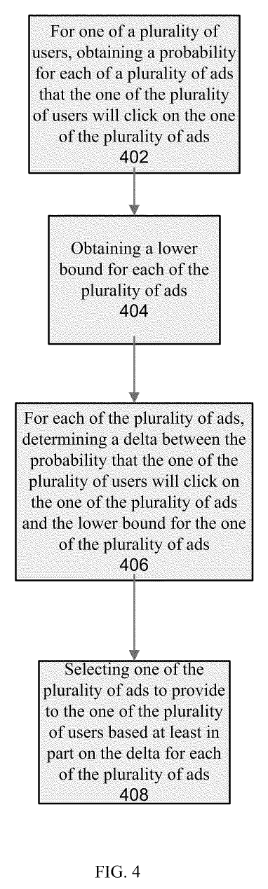

FIG. 4 is a process flow diagram illustrating an example general method of delivering online advertisements in accordance with various embodiments. For one of a plurality of users, a probability may be obtained for each of a plurality of ads that the user will click on the ad at 402. For instance, the probability may be obtained using a statistical model that has been generated based upon user data that has been collected in association with various users. Specifically, the system may create a statistical model from previously collected user data associated with the plurality of users, wherein the previously collected user data associated with the plurality of users indicates previous behavior of each of the plurality of users, enabling the probability for each of the plurality of ads that the user will click on the ad to be performed based upon the statistical model. Accordingly, the probability for each of a plurality of ads that one of the plurality of users will click on the one of the plurality of ads may be determined based upon prior behavior of the plurality of users (as well as other information).

A lower bound may be obtained for each of the plurality of ads at 404. As described above with reference to 402, for one of the plurality of users, a probability may be obtained for each of the plurality of ads that the user will click on the ad, resulting in a plurality of probabilities being obtained for the user. In one embodiment, probabilities may be obtained in this manner for each of the plurality of users at 402. Specifically, for each of the plurality of users, a probability may be obtained for each of a plurality of ads that the corresponding one of the plurality of users will click on the one of the plurality of ads. An optimization model such as that described below may be applied to obtain the lower bound for each of the plurality of ads. Specifically, the optimization model may maximize the total probability of clicks for the ads (over all of the users), while maintaining the total number of impressions for each of the ads. The lower bound for each of the plurality of ads may then be obtained using the probabilities obtained for the plurality of users (e.g., using the optimization model). An example optimization model will be described in further detail below.

For each of the plurality of ads, the system may determine a delta between the probability that the user will click on the ad and the lower bound for the ad at 406. The system may then select one of the ads to provide to the user based at least in part on the delta for each of the plurality of ads at 408. In one embodiment, one of the plurality of ads can be provided to the one of the plurality of users if the probability that the one of the plurality of users will click on the one of the plurality of ads is greater than the lower bound for the one of the plurality of ads. In other words, an ad may be provided to the user if the delta is greater than zero. In another embodiment, the system may compare the delta for each of the plurality of ads to identify one of the plurality of ads having a highest delta. The system may then select the identified one of the plurality of ads having the highest delta.

In accordance with yet another embodiment, the above delta value may be further compensated by an actual delivery error. To calculate the delivery error, for each of the advertisements, the system may identify a number of impressions previously allocated to the ad during a period of time, a requested number of impressions for the ad during the period of time, a total number of impressions planned to be served during the period of time, and a total number of impressions already served during the period of time. Thus, the system may select one of the ads to provide to the user based upon the number of impressions previously allocated to the one of the plurality of ads during the period of time, the requested number of impressions for the one of the plurality of ads during the period of time, the total number of impressions planned to be served during the period of time, and/or the total number of impressions already served during the period of time, as well as the delta for each of the ads. The delivery error can be added to the above delta calculation as a weighted parameter, or can be added periodically as an online adjustment to the lower bounds. One example method of calculating the delivery error will be described in further detail below.

The system may dynamically select an advertisement to provide to the user. For instance, the system may select one of the ads when the user visits a web page via the Internet. The system may then provide the selected one of the plurality of ads to the user.

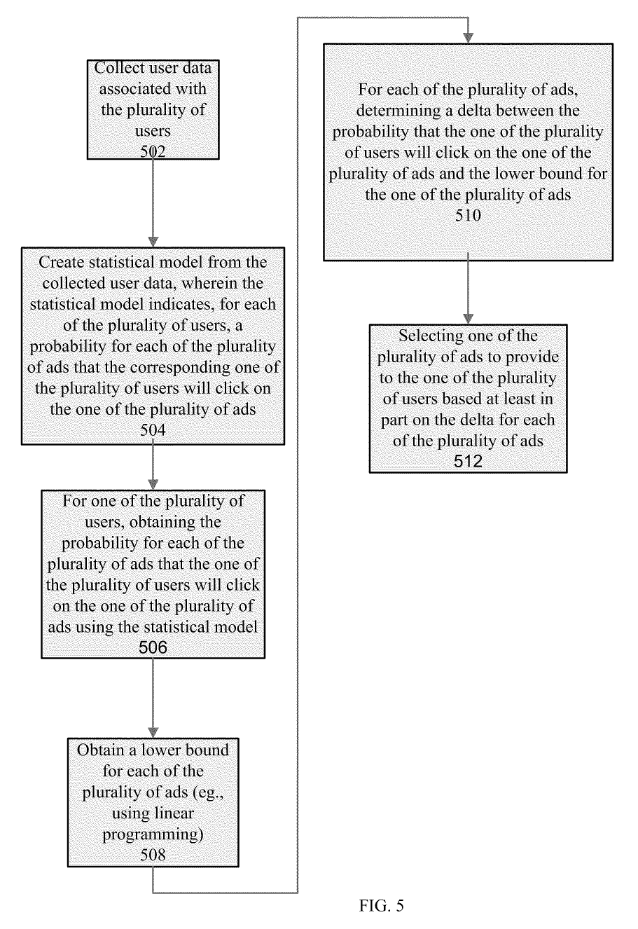

FIG. 5 is a process flow diagram illustrating an example detailed method of delivering online advertisements in accordance with various embodiments. The system may collect user data associated with a plurality of users at 502. The system may then create a statistical model from the user data at 504. As set forth above, the statistical model may indicate, for each of the plurality of users, a probability for each of the plurality of ads that the corresponding one of the plurality of users will click on the one of the plurality of ads. For one of the plurality of users, the system may obtain the probability for each of the plurality of ads that the one of the plurality of users will click on the one of the plurality of ads from the statistical model at 506. The system may obtain a lower bound for each of the plurality of ads at 508. For each of the plurality of ads, the system may determine a delta between the probability that the one of the plurality of users will click on the one of the plurality of ads and the lower bound for the one of the plurality of ads at 510. The system may then select one of the ads to provide to the user based at least in part on the delta for each of the ads at 512. For instance, the system may select one of the plurality of ads when the user visits a web page via the Internet. The system may then provide the selected one of the plurality of ads to the user when the user visits a web page via the Internet.

### EXAMPLE

In order to illustrate an example application of the disclosed embodiments, we set forth a specific method of serving advertisements by using linear programming. Assume we have a list of advertisements A={a₁, a₂, . . . aₖ} to serve at a certain page space. The number of impressions the system is to serve for each advertisement is typically specified in a contract with the advertiser for that advertisement. In other words, for each advertisement aᵢ, the system may be responsible for delivering a requested number of impressions, Mᵢ impressions, over a particular period of time (e.g., per day).

When a user u visits a web page, one can calculate an estimated probability pᵢ(u)of the user clicking on the ad aᵢ for each of the advertisements. These probabilities may be obtained using data mining techniques, such as logistic regression or naive Bayesian methods. However, by merely considering the probability that this particular user will click on the ad may result in less than optimal results.

We may maximize the total of the probabilities for each of the ads over all of the users, while delivering the targeted number of impressions (e.g., requested number of impressions) for each of the advertisements within the particular period of time (e.g., by the end of the day). Accordingly, the system may maximize the total probabilities by modeling this problem as a constrained optimization problem.

Using historical user data that has been collected, we may create a statistical model with a linear program formulation. A set of lower bounds or cutoff values for each of the advertisements may be obtained by obtaining a solution to the statistical model (e.g., the linear programming formulation). At runtime, the lower bounds may be used to determine which ad to deliver to a particular user. Assuming the incoming user flow is proportionally similar to that of the training data (e.g., historical user data that has been collected), the approach is capable of achieving a near optimal solution to the advertisement delivery problem.

An example optimization model implementing a linear formulation, set forth below, may be used to maximize the total probabilities of user click through while delivering the targeted number of impressions for each advertisement. Let x(u,i) be the decision variable that indicates whether we should serve advertisement aᵢ to user u.

### Constraints

Each user is served one advertisement,

Σᵢx(u,i)=1, ∀u, (1.1)
Each advertisement is delivered the targeted number,

Σᵤx(u,i)≦Mᵢ, ∀i=1, . . . ,k, (1.2)
The 0, 1 condition of variables,

x(u,i)≧0,∀u,i, (1.3)

### Objective Function

Maximize the total probabilities of user click through:

max ΣᵤΣᵢpᵢ(u)x(u,i) (1.4)

Because (1.1)-(1.3) form a bipartite b-matching problem, a combinatorial or a linear program can easily find a 0-1 solution for very large problem sizes.

Using the optimized delivery plan represented by the linear programming formulations (1.1)-(1.4), the lower bounds for the advertisements may be obtained. One method of obtaining the lower bounds is described below.

### Dual Formulation

Let πᵤ, πᵢ be the dual variable correspond to (1.1) and (1.2) respectively, the linear programming dual for (1.1)-(1.4) can be written as follows.

πᵤ+πᵢ≧pᵢ(u),∀u,i (2.1)

πᵢ≧0,∀i (2.2)

min Σᵤπᵤ+ΣᵢMᵢπᵢ (2.3)

By the duality theory, at the optimal solution, x(u,i)=1 implies πᵤ=pᵢ(u)−πᵢ. From there, we derive our runtime algorithm: for each u, we find i that maximizes pᵢ(u)−πᵢ for advertisement aᵢ. In other words, for each of the plurality of ads aᵢ, the system may determine a delta (Δ) between the probability that the user will click on the one of the plurality of ads, pᵢ(u), and the lower bound for the one of the plurality of ads, πᵢ. The advertisement aᵢ having the highest delta, pᵢ(u)−πᵢ, may then be served to user u. In this manner, the lower bound, πᵢ, that provides the maximum delta, pᵢ(u)−πᵢ, may be obtained and used to select advertisement aᵢ to serve to user u. Thus, the system may select one of the plurality of ads to provide to the one of the plurality of users based on the delta, pᵢ(u)−πᵢ, for each of the plurality of ads. Accordingly, the lower bound for each of the advertisements may be used to select one of the advertisements to serve to the user u.

In one embodiment, in order to guarantee the delivery of the requested number impressions for each of the advertisements, we may make up any possible under served or over served advertisement from time to time. We can do this by taking the difference of the percentage of the time passed for the period of time (e.g., day) verses the percentage of the impressions (i.e., views) already served for advertisement aᵢ, and add this difference to πᵢ. More specifically, at any time, let mᵢ be the number of impressions already served for advertisement aᵢ and let t=Σᵢmᵢ. In other words, t represents the total number of impressions that have been served for all of the advertisements. Let T=ΣᵢMᵢ be the total number of impressions planned to serve, as requested by the advertisers. The difference is

eᵢ=(t/T)−(mᵢ/Mᵢ).

This difference is a measure of how urgent we should deliver more of aᵢ to make sure that the targeted Mᵢ impressions are delivered by the end of the period of time (e.g., day). The difference, eᵢ, may be referred to as a delivery error.

When a user u comes to visit the web page, we may calculate the following value

rᵢ=pᵢ(u)−πᵢ+θeᵢ,

for each i, where θ is a parameter that can be determined by the experiment. We may deliver the advertisement that has the maximum rᵢ value to user u. Thus, the system may select one of the plurality of ads to provide to the one of the plurality of users based at least in part on the delta, pᵢ(u)−πᵢ for each of the plurality of ads.

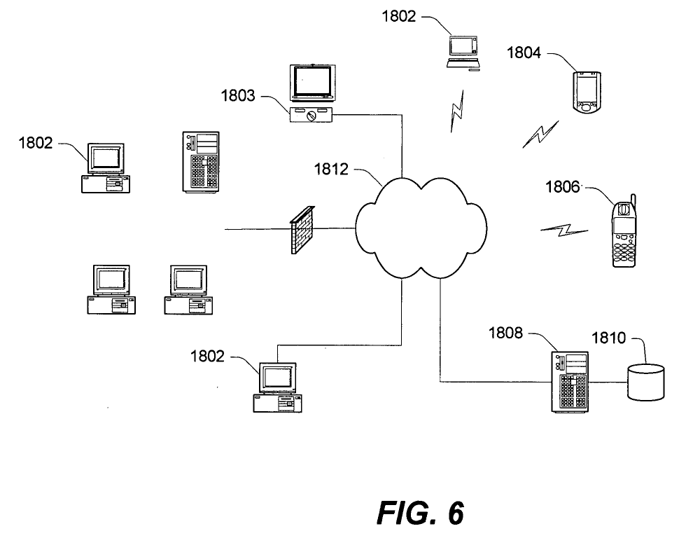

The disclosed embodiments may be employed to automatically select and deliver advertisements to provide to various users in any of a wide variety of computing contexts. For example, as illustrated in FIG. 6, implementations are contemplated in which users interact with a diverse network environment via any type of computer (e.g., desktop, laptop, tablet, etc.) 1802, media computing platforms 1803 (e.g., cable and satellite set top boxes and digital video recorders), handheld computing devices (e.g., PDAs) 1804, cell phones 1806, or any other type of computing or communication platform.

And according to various embodiments, input that is processed in accordance with the invention may be obtained using a wide variety of techniques. For example, a search query may be obtained from a user's interaction with a local application, web site or web-based application or service and may be accomplished using any of a variety of well known mechanisms for obtaining information from a user. However, it should be understood that such methods of obtaining input from a user are merely examples and that a search query may be obtained in many other ways.

User data may be collected and/or processed to select and deliver advertisements in accordance with the disclosed embodiments in some centralized manner. This is represented in FIG. 6 by server 1808 and data store 1810 which, as will be understood, may correspond to multiple distributed devices and data stores. The invention may also be practiced in a wide variety of network environments (represented by network 1812) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. The advertisement delivery apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store historical user data, advertisements, contract information including requested number of impressions, statistical models and information generated from those statistical models (e.g., probabilities associated with users in association with various advertisements), lower bounds associated with advertisements, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

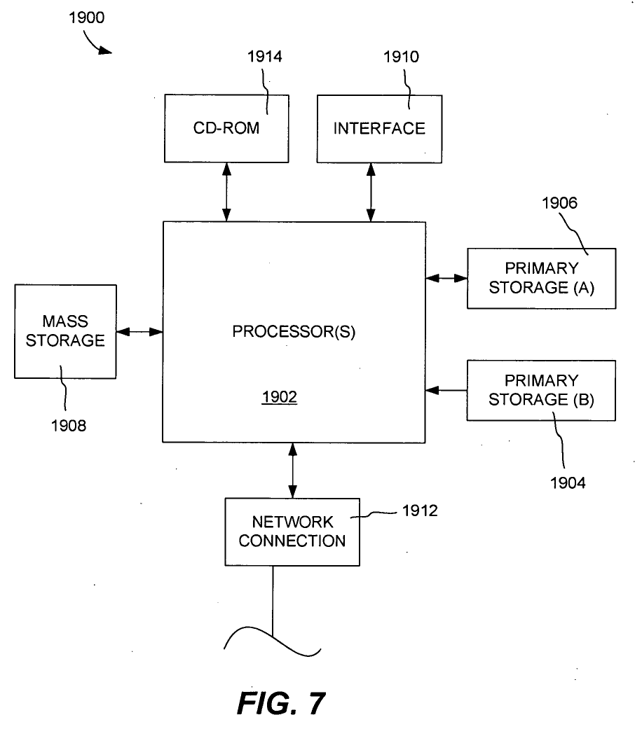

FIG. 7 illustrates a typical computer system that, when appropriately configured or designed, can serve as a system of this invention. The computer system 1900 includes any number of processors 1902 (also referred to as central processing units, or CPUs) that are coupled to storage devices including primary storage 1906 (typically a random access memory, or RAM), primary storage 1904 (typically a read only memory, or ROM). CPU 1902 may be of various types including microcontrollers and microprocessors such as programmable devices (e.g., CPLDs and FPGAs) and unprogrammable devices such as gate array ASICs or general purpose microprocessors. As is well known in the art, primary storage 1904 acts to transfer data and instructions uni-directionally to the CPU and primary storage 1906 is used typically to transfer data and instructions in a bi-directional manner. Both of these primary storage devices may include any suitable computer-readable media such as those described above. A mass storage device 1908 is also coupled bi-directionally to CPU 1902 and provides additional data storage capacity and may include any of the computer-readable media described above. Mass storage device 1908 may be used to store programs, data and the like and is typically a secondary storage medium such as a hard disk. It will be appreciated that the information retained within the mass storage device 1908, may, in appropriate cases, be incorporated in standard fashion as part of primary storage 1906 as virtual memory. A specific mass storage device such as a CD-ROM 1914 may also pass data uni-directionally to the CPU.

CPU 1902 may also be coupled to an interface 1910 that connects to one or more input/output devices such as such as video monitors, printers, track balls, mice, keyboards, microphones, displays such as touch-sensitive displays, transducer card readers, magnetic or paper tape readers, tablets, styluses, voice or handwriting recognizers, or other well-known input devices such as, of course, other computers. Finally, CPU 1902 optionally may be coupled to an external device such as a database, or a computer or telecommunications network using an external connection as shown generally at 1912. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
for one of a plurality of users, obtaining a probability for each of a plurality of ads that the one of the plurality of users will click on the one of the plurality of ads;
obtaining a lower bound for each of the plurality of ads;
for each of the plurality of ads, determining a delta between the probability that the one of the plurality of users will click on the one of the plurality of ads and the lower bound for the one of the plurality of ads; and
selecting one of the plurality of ads to provide to the one of the plurality of users based at least in part on the delta for each of the plurality of ads.

2. The method as recited in claim 1, wherein one of the plurality of ads can be provided to the one of the plurality of users if the delta between the probability that the one of the plurality of users will click on the one of the plurality of ads and the lower bound for the one of the plurality of ads is greater than the lower bound for other ads in the plurality of ads.

3. The method as recited in claim 1, wherein selecting one of the plurality of ads comprises:
comparing the delta for each of the plurality of ads to identify one of the plurality of ads having a highest delta; and
selecting the identified one of the plurality of ads having the highest delta.

4. The method as recited in claim 1, further comprising:
for each of the plurality of ads, identifying a number of impressions previously allocated to the one of the plurality of ads during a period of time, a requested number of impressions for the one of the plurality of ads during the period of time, a total number of impressions planned to be served during the period of time, and a total number of impressions already served during the period of time;
wherein selecting one of the plurality of ads to provide to the one of the plurality of users is further based upon the number of impressions previously allocated to the one of the plurality of ads during the period of time, the requested number of impressions for the one of the plurality of ads during the period of time, the total number of impressions planned to be served during the period of time, and the total number of impressions already served during the period of time.

5. The method as recited in claim 1, wherein selecting one of the plurality of ads is performed when the one of the plurality of users visits a web page via the Internet.

6. The method as recited in claim 1, further comprising:
providing the selected one of the plurality of ads to the one of the plurality of users when the one of the plurality of users visits a web page via the Internet.

7. The method as recited in claim 1, further comprising:
collecting user data associated with the plurality of users; and
creating a statistical model from the user data, wherein the statistical model indicates, for each of the plurality of users, a probability for each of the plurality of ads that the one of the plurality of users will click on the one of the plurality of ads;
wherein obtaining the probability is performed based upon the statistical model.

8. The method as recited in claim 7, wherein the user data indicates prior behavior of the plurality of users.

9. The method as recited in claim 7, wherein the user data indicates for each of the plurality of users, prior behavior with respect to a plurality of categories and a subset of the plurality of ads previously clicked on.

10. The method as recited in claim 7, wherein the user data associated with each of the plurality of users further indicates at least one of a location, age, or sex of the corresponding one of the plurality of users.

11. The method as recited in claim 7, wherein the user data associated with each of the plurality of users further indicates a purchase history of the corresponding one of the plurality of users.

12. The method as recited in claim 1, further comprising;
creating a statistical model from previously collected user data associated with the plurality of users, wherein the previously collected user data associated with the plurality of users indicates previous behavior of each of the plurality of users;
wherein obtaining the probability is performed based upon the statistical model.

13. The method as recited in claim 1, wherein the probability for each of a plurality of ads that the one of the plurality of users will click on the one of the plurality of ads is determined based upon prior behavior of the plurality of users.

14. The method as recited in claim 1, further comprising:
for each of the plurality of users, obtaining a probability for each of a plurality of ads that the corresponding one of the plurality of users will click on the one of the plurality of ads; wherein the lower bound is obtained such that a minimum number of impressions associated with each of the plurality of ads is satisfied.

15. An apparatus, comprising:
a processor; and
a memory, at least one of the processor or the memory being adapted for:
collecting user data associated with a plurality of users; and
creating a statistical model from the user data, wherein the statistical model indicates, for each of the plurality of users, a probability for each of the plurality of ads that the corresponding one of the plurality of users will click on the one of the plurality of ads;
for one of the plurality of users, obtaining the probability for each of the plurality of ads that the one of the plurality of users will click on the one of the plurality of ads using the statistical model;
obtaining a lower bound for each of the plurality of ads;
for each of the plurality of ads, determining a delta between the probability that the one of the plurality of users will click on the one of the plurality of ads and the lower bound for the one of the plurality of ads; and
selecting one of the plurality of ads to provide to the one of the plurality of users based at least in part on the delta for each of the plurality of ads.

16. The apparatus as recited in claim 15, wherein the lower bound for each of the plurality of ads is obtained using an optimization model that guarantees that a minimum number of impressions associated with each of the plurality of ads is satisfied.

17. The apparatus as recited in claim 16, wherein the optimization model further maximizes a total probability for each of the plurality of ads that the plurality of users will click on the one of the plurality of ads.

18. A computer-readable medium storing thereon computer-readable instructions for performing steps comprising:
for one of a plurality of users, obtaining a probability for each of a plurality of ads that the one of the plurality of users will click on the one of the plurality of ads;
obtaining a lower bound for each of the plurality of ads;
for each of the plurality of ads, determining a delta between the probability that the one of the plurality of users will click on the one of the plurality of ads and the lower bound for the one of the plurality of ads; and
selecting one of the plurality of ads to provide to the one of the plurality of users based at least in part on the delta for each of the plurality of ads.

19. The computer-readable medium as recited in claim 18, wherein the lower bound for each of the plurality of ads is obtained using an optimization model that guarantees that a minimum number of impressions corresponding to each of the plurality of ads is satisfied.

20. The computer-readable medium as recited in claim 19, wherein the optimization model further maximizes a total probability for each of the plurality of ads that the plurality of users will click on the one of the plurality of ads.
